(19) United States
(12) Patent Application Publication
(10) Pub. No.: US 2011/0207003 A1
(43) Pub. Date: Aug. 25, 2011

(54) Method for removing CO, H2 and/or CH4 from the anode waste gas of a fuel cell with mixed oxide catalysts comprising Cu, Mn and optionally at least one rare earth metal

(75) Inventors: Hans-Georg Anfang, Schechen (DE); Alberto Cremona, Castell' Arquato (Piacenza) (IT); Sandra Reheis, Reichersbeuern (DE)

(73) Assignee: SUD-CHEMIE AG, Munchen (DE)

(21) Appl. No.: 12/671,737

(22) PCT Filed: Jul. 30, 2008
(86) PCT No.: PCT/EP08/60024

§ 371 Date: May 2, 2011

(30) Foreign Application Priority Data
Aug. 10, 2007 (DE) 10 2007 037 796.9

(51) Int. Cl. H01M 8/06

(52) U.S. Cl. 429/412; 429/410; 429/408

(57) ABSTRACT

The invention relates to a method for removing CO, H₂ and/or CH₄ from the anode waste gas of a fuel cell using mixed oxide catalysts comprising Cu, Mn and optionally at least one rare earth metal and to the use of mixed oxide catalysts comprising Cu, Mn, and optionally at least one rare earth metal for removing CO, H₂ and/or CH₄ from the anode waste gas of a fuel cell, and to a fuel cell arrangement.

The present invention relates to fuel cell arrangements and systems, comprising a catalytic waste gas burner for the combustion of a mixture of anode tail gas, air and/or other admixed gases (e.g. cathode waste gas), wherein a mixed oxide catalyst comprising Cu and Mn is used as catalyst in the waste gas burner, and also to a method and use for this.

Fuel cells make it possible to obtain electrical current with high efficiency from the controlled combustion of hydrogen. However, an infrastructure for the future energy source, hydrogen, does not yet exist. It is therefore necessary to obtain hydrogen from the readily available energy sources natural gas, gasoline, diesel or other hydrocarbons such as biogas, methanol, etc.

Hydrogen can be produced from methane—the predominant constituent of natural gas—for example by steam reforming. In addition to traces of unconverted methane and water, the resulting gas essentially contains hydrogen, carbon dioxide and carbon monoxide. This gas can be used as fuel gas for a fuel cell. To shift the balance towards hydrogen during steam reforming, this is carried out at temperatures of approximately 500° C.-1000° C., wherein this temperature range is to be adhered to as exactly as possible for a constant composition of the fuel gas.

Sulphur compounds present in the fuel gas are usually removed prior to the feed to the fuel cell, as most fuel cell catalysts used are sensitive to sulphur.

A fuel cell arrangement in which the fuel gas produced from methane and water can be used to generate energy is described for example in DE 197 43 075 A1. Such an arrangement comprises a number of fuel cells which are arranged in a fuel cell stack inside a closed protective housing. Fuel gas which essentially consists of hydrogen, carbon dioxide, carbon monoxide and residues of methane and water is fed to the fuel cells via an anode gas inlet. The fuel gas is produced from methane and water either in an upstream external reformer or in an internal reformer. Internal reforming reactions are often carried out in high-temperature fuel cells such as e.g. MCFCs (molten carbonate fuel cells) or SOFCs (solid oxide fuel cells), as the exothermic electrochemical reaction energy of the fuel cell can be used directly for the strongly endothermic reforming reaction.

An internal reforming of hydrocarbons is carried out for example in the “molten carbonate fuel cells” (MCFCs) described in DE 197 43 075 A1 and in US 2002/0197518 A1. The fuel cell generates current and heat via the following electrochemical reactions:

Cathode: ½O₂+CO₂+2e⁻→CO₃²⁻

Anode: H₂+CO₃²⁻→CO₂+H₂O+2e⁻

Electrochemical reactions are exothermic. To counter this, therefore, a catalyst for the steam reforming reaction of methane can be arranged directly in the cell:

CH₄+H₂O→CO+3H₂

CH₄+2H₂O→CO₂+4H₂

This reaction is strongly endothermic and can directly consume the heat being released from the electrochemical reactions. As steam reforming is a balanced reaction, the balance can moreover be shifted by a continuous removal of hydrogen at the anode. Only thereby can almost complete methane conversions be achieved at relatively low temperatures of approx. 650° C.

Despite the high efficiency of the fuel cell, in addition to the reaction products carbon dioxide and water, the anode waste gas still contains hydrogen, carbon monoxide and methane gas, depending on the operating conditions and duration.

To remove residues of hydrogen, therefore, the anode waste gas is first mixed with air and then fed to a catalytic waste gas burner in which the remaining methane and also traces of hydrogen are burned to water and carbon dioxide. Optionally or alternatively, in addition to the anode waste gas and air, other gases such as e.g. cathode waste gas can be admixed. The thermal energy released in the process can be used in different ways.

On the one hand, noble metals, for example platinum and/or palladium, which are provided in finely-distributed form on a suitable support, are currently used as catalysts in the waste gas burner. This catalytic combustion has the advantage that it is very steady and has no temperature peaks. The combustion on palladium catalysts proceeds at temperatures in the range from approximately 450 to 550° C. At higher temperatures of over approximately 800 to 900° C., the Pd/PdO balance shifts in favour of palladium metal, whereby the activity of the catalyst decreases (see Catalysis Today 47 (1999) 29-44). A loss of activity is furthermore to be observed as a result of sintering occurring or the caking of the catalyst particles. In principle, however, noble metal catalysts have the disadvantage of very high raw material prices.

On the other hand, heat-stable catalysts for the catalytic combustion of methane for example are known from EP 0 270 203 A1. These are based on alkaline earth hexa-aluminates which contain Mn, Co, Fe, Ni, Cu or Cr. These catalysts are characterized by a high activity and resistance even at temperatures of more than 1200° C. However, the activity of the catalyst is relatively low at lower temperatures. To be able to provide an adequate catalytic activity also at lower temperatures, small quantities of platinum metals are added, for example Pt, Ru, Rh or Pd.

M. Machida, H. Kawasaki, K. Eguchi, H. Arai, Chem. Lett. 1988, 1461-1464 further describe hexa-aluminates substituted with manganese A_{1-X}A′ₓMnAl₁₁O_{19-α} which have a high specific surface area even after calcining at temperatures of approximately 1300° C. H. Sadamori, T. Tanioka, T. Matsuhisa, Catalysis Today, 26 (1995) 337-344 describe the use of this hexa-aluminate in a catalytic burner which is connected upstream of a gas turbine. However, this ceramic catalyst displays a relatively high ignition temperature of over 600° C. during the combustion of methane. Sections in which a noble metal-containing catalyst is arranged are therefore connected upstream of the ceramic catalyst.

Finally, DE 10 2005 062 926 A1 describes that, through an intensive grinding of hexa-aluminates, their activity can be increased to such an extent that ignition temperatures in the range from 300 to 500° C. and operating temperatures in the range from approximately 500 to 1100° C. can be achieved during the combustion of methane.

The ideal temperature range for the operation of a high-temperature fuel cell lies in the range from approximately 400 to 1000° C. The heat resulting during the anode waste gas combustion can be used in different applications, for example to evaporate water for the steam reforming, to provide heat energy for the endothermic steam reforming, to use heat in combined heat and power generation applications or the like. The completely oxidized anode waste gas which in particular no longer contains hydrogen gas can be fed to the cathode as cathode gas after emerging from the burner. This is described for example in DE 197 43 075 A1.

There is a need for a cost-favourable, active catalyst with long-term stability for fuel cell arrangements which comprise a catalytic waste gas burner for the combustion of a mixture of anode tail gas, air and optionally other gases such as cathode gases, which is stable and active for the methane, CO and H₂ oxidation in the waste gas burner at temperatures of 400 to 1100° C.

It was surprisingly found that oxidation catalysts, comprising mixed oxides of copper, manganese and optionally one or more rare earth metal(s), are particularly suitable for this.

In particular, these catalysts make it possible to recover industrial heat, to prepare CO₂ for a recirculation system of the fuel cell type MCFC (molten carbonate fuel cell) and to reduce environmental emissions.

A subject of the present invention is therefore a method for removing CO, H₂ and/or CH₄ from the anode waste gas of a fuel cell with mixed oxide catalysts comprising Cu, Mn and optionally at least one rare earth metal.

Another subject of the present invention is the use of mixed oxide catalysts comprising Cu, Mn and optionally at least one rare earth metal to remove CO, H₂ and/or CH₄ from the anode waste gas of a fuel cell.

As the anode waste gas is already sulphur-free or sufficiently low in sulphur in the fuel gas as a result of the removal of possibly present sulphur compounds, there is no need for catalysts suitable for the present invention to be insensitive to sulphur.

Suitable catalysts are described for example in EP 1 197 259, the disclosure of which is herewith incorporated into the present invention by reference. Such catalysts comprise mixed oxides of Cu, Mn and rare earth metal(s) in which the metals can assume multivalence states, which have a wt.-% composition expressed as the oxides which are specified as follows: 50-60% as MnO, 35-40% as CuO and 2-15% as La₂O₃ and/or as oxides of the rare earth metals in the lowest valence state. The composition is preferably 50-60% MnO, 35-40% CuO, 10-12% La₂O₃.

The individual metals can also assume oxidation states other than those mentioned above. For example, manganese can also be present as MnO₂.

In general, the following compositions are possible, wherein the percentages are weight percentages relative to the total mass of Mn, Cu and optionally rare earth metals: Mn 80-20%, Cu 20-60%, rare earth metals 0-20%, preferably Mn 75-30%, Cu 20-55%, rare earth metals 5-15%.

The mass ratio of copper to manganese (calculated as Cu mass to Mn mass) on the finished catalyst can be for example 0.4 to 0.9, preferably 0.5 to 0.75.

By rare earth metals are meant lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu). La and Ce are preferred.

The oxides are supported for example on porous inorganic supports such as aluminium oxide, silicon dioxide, silicon dioxide-aluminium oxide, titanium dioxide or magnesium oxide. The oxides are supported in a quantity of generally 5 to 50 wt.-%, preferably 5 to 30 wt.-%, relative to the total mass of the catalyst and of the oxides. The rare earth metal can be already present in the support. The main role of the rare earth metal is to stabilize the BET surface area of the porous inorganic support. An example known to a person skilled in the art is lanthanum-stabilized aluminium oxide.

The catalyst can be prepared by first impregnating the support with a solution of a salt of lanthanum or cerium or another rare earth metal, drying it and then calcining it at a temperature of approximately 600° C. If the support already contains a rare earth metal for preparation-related reasons this step can be dispensed with. Examples are aluminium oxides stabilized with lanthanum.

The support is then impregnated with a solution of a copper and manganese salt, then dried at 120 to 200° C. and calcined at up to 450° C.

Any soluble salt of the metals can be used. Examples of salts are nitrates, formates and acetates. Lanthanum is preferably used as lanthanum nitrate La(NO₃)₃, copper and manganese are preferably used as nitrates, namely Cu(NO₃)₂ and Mn(NO₃)₃.

A preferred impregnation process is dry impregnation, wherein a quantity of solution is used which is equal to or less than the pore volume of the support.

Particularly suitable for the purposes of the present invention is the catalyst prepared according to example 1 of EP 1 197 259 A1, which is supported on γ-aluminium oxide and in which the mixed oxides have the following composition expressed as wt.-% of the oxides given in the following: La₂O₃=9.3, MnO =53.2, CuO=37.5.

In some applications, it may be necessary for the starting temperature of the catalyst to be less than 250° C. That means that the catalyst should be in a position to convert H₂ and CO at temperature below approximately 250° C. in order to achieve an exothermic effect which is needed to initiate the methane combustion reaction. As the H₂ and CO conversion activity of the catalysts used within the framework of this invention is low, a doping with small quantities of noble metals can be advantageous. Platinum (Pt) and/or palladium (Pd) for example are suitable for this. The catalyst can be doped for example with 0.1 wt.-% Pt.

Furthermore, hopcalite catalysts can be used within the framework of the present invention. These are mixed catalysts which mainly consist of manganese dioxide and copper(II) oxide. In addition, they can contain further metal oxides, for example cobalt oxides and silver(I) oxide.

The present invention furthermore relates to a fuel cell arrangement, comprising a waste gas burner, wherein the waste gas burner has mixed oxide catalysts comprising Cu, Mn and optionally at least one rare earth metal. In particular, the invention relates to fuel cells of the MCFC (molten carbonate fuel cell) or SOFC (solid oxide fuel cell) type in which the waste gas burner has mixed oxide catalysts comprising Cu, Mn and optionally at least one rare earth metal.

The waste gas burner of the fuel cell arrangement according to the invention preferably has, as mixed oxide catalysts, oxidation catalysts which comprise mixed oxides of copper, manganese and one or more rare earth metal(s), wherein the metals can assume multivalence states which have a weight-percent composition expressed as CuO, MnO and rare earth metal oxides, in which the rare earth metal has the lowest valence, of 35 to 40%, 50 to 60% and 2 to 15% respectively.

The waste gas burner can in principle have mixed oxides of all of the above-mentioned compositions, in particular 20-60% Cu, 80-20% Mn and 0-20% rare earth metal (weight percentages; relative to the total weight of the given metals).

The invention is described in more detail using the following figures and examples, without being limited by them.

### FIGURES

FIG. 1 shows a steady-state test in which the temperature of the catalyst bed is plotted against time. No reaction gas has yet been passed over the catalyst bed.

FIG. 2 shows the absolute CH₄ concentration as a function of the time-on-stream (TOS) for different Pt/Pd catalyst types on 600 cpsi metal monoliths.

FIG. 3 shows the absolute CH₄ concentration as a function of the TOS for Cu/La/Mn catalysts.

FIG. 4 shows the methane conversion as a function of the inflow temperature in Cu/La/Mn bulk material.

FIG. 5 shows the CO conversion as a function of the catalyst inflow temperature for fresh and aged Cu/La/Mn catalysts.

FIG. 6 shows the H₂ conversion as a function of the catalyst inflow temperature for fresh and aged Cu/La/Mn catalysts.

FIG. 7 shows the CO, H₂ and CH₄ conversion as a function of the catalyst inflow temperature for fresh Cu/La/Mn catalysts which are doped with 0.1% Pt.

FIG. 8 shows a schematic representation of the test structure.

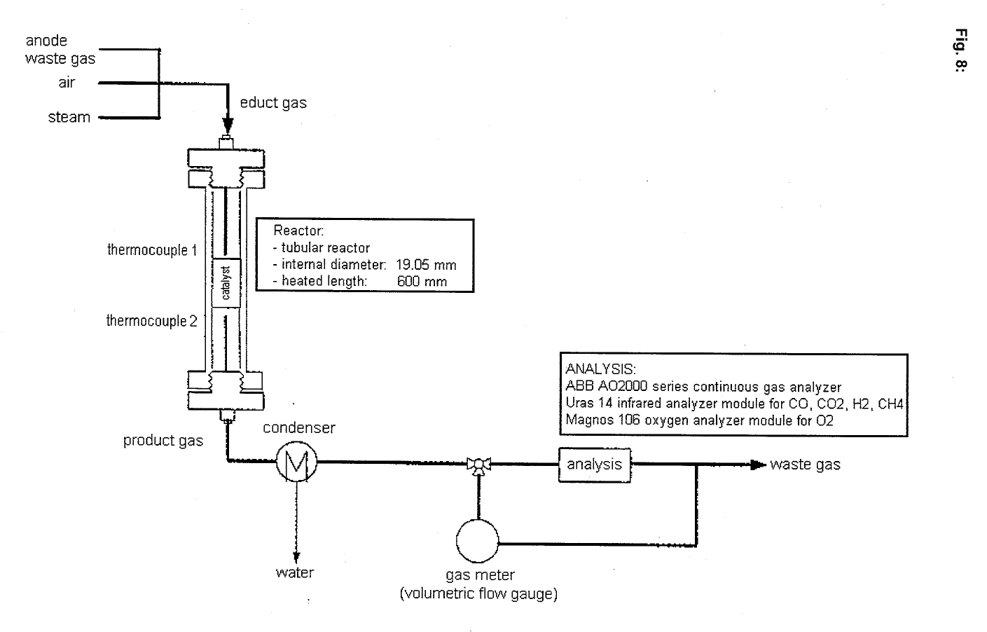

### EXAMPLES

Within the framework of the following application examples, a test gas mixture is used which is similar to an anode waste gas after being mixed with air:

| CH₄: | 0.56 | vol.-% |
|---|---|---|
| CO: | 1.13 | vol.-% |
| H₂: | 2.30 | vol.-% |
| O₂: | 16 | vol.-% |
| N₂: | balance | |
| CO₂: | 9.5 | vol.-% |
| H₂O: | 12 | vol.-% |

The catalytic activity for the anode waste gas oxidation of different catalysts is tested in a conventional tubular reactor at atmospheric pressure. The tubular reactor has an internal diameter of approx. 19.05 mm and a heated length of 600 mm and consists of an austenitic special steel based on Ni. Above and below the catalyst, the gas inlet and gas outlet temperatures are measured during the test.

The test gas mixture is fed to the tubular reactor with a total GHSV (gas hourly space velocity) of 25,000 NL/h/L in the case of coated metal monoliths (Emitec, 400 cpsi and 600 cpsi metal monoliths, V=7.4 mL) and 18,400 NL/h/L in the case of the bulk material test (pressure: 50 to 70 mbarg). Bulk materials were prepared analogously to the following examples and tested in screened-out particle-size fractions of 1-2 mm particle diameter.

Educt and product gases are analyzed online with an IR analyzer: ABB AO2000 series continuous gas analyzer: Uras 14 infrared analyzer module for CO, CO₂, H₂, CH₄; Magnos 106 oxygen analyzer module for O₂. This gas analyzer was calibrated with corresponding certified test gases prior to the start of the test.

The aging of the catalysts takes place under the following conditions in tubular reactors:

Hydrothermal aging:
750° C. in air with 20% water vapour for at least 40 hours, GHSV of 1000 NL/h/L based on the catalyst (182 hours TOS for extended-time tests).
   Hydrothermal potassium aging:
50 mL Al₂O₃ spheres (SPH 515; manufacturer Rhodia), impregnated with K₂CO₃ (5.5 mass-% K) and dried at 120° C. for 12 hours, which had previously been converted from gamma- to alpha-Al₂O₃ at 1300° C. for 10 hours, were deposited on a 10-mL catalyst bed, and air and 20% water vapour flowed through the bed at 750° C. (e.g. for 65 hours, GHSV of 1000 NL/h/L based on the catalyst). The hydrothermal potassium aging is to simulate the process occurring in MCFCs in which potassium escapes from the electrolytes by continuous evaporation and can be found again in the anode waste gas stream. With regard to the effect of the presence of potassium in anode gases of MCFCs, reference is made to S. CAVALLARO et al., Int. J. Hydrogen Energy, Vol. 17. No. 3, 181-186, 1992; J. R. Rostrup-Nielsen et al., Applied Catalysis A: General 126 (1995) 381-390; and Kimihiko Sugiura et al., Journal of Power Sources 118 (2003) 228-236.

### Preparation Example 1

### Comparison Catalyst Based on Pt/Pd

A Pt/Pd catalyst is used for the comparative tests. The 400 or 600 cpsi metal honeycombs are coated with washcoat according to U.S. Pat. No. 4,900,712, example 3 (solids content 40-50%) (theoretical loading 90 g/l). The coated honeycombs are dried in the drying oven at 120° C. for two hours and calcined at 550° C. for three hours (ramp rate 2° C./min). The calcined honeycombs are impregnated with Pt as PSA (platinum sulphite acid; 0.71 g/l; w (Pt)=9.98%; Heraeus, batch CPI13481) by total adsorption, wherein the dipping solution is to be prepared by a dilution series, as otherwise the quantity weighed in is too small. The honeycombs are left in the dipping solution over night (for at least 12 hours), in order to ensure that all of the Pt is taken up. The honeycombs are then blown out and dried in the drying oven at 120° C. for two hours and then calcined at 550° C. for three hours (ramp rate 2° C./min). The calcined honeycombs are impregnated with Pd as palladium tetramine nitrate (2.13 g/l; w(Pd)=3.30%; Umicore, batch 5069/00-07), wherein the solutions are prepared individually for each honeycomb. The water uptake of the calcined honeycombs is determined by dipping the honeycombs in water for 30 seconds, blowing them out and weighing them. The concentration of the solution depends on the water uptake (e.g. water uptake 0.45 g/honeycomb→Pd loading for this honeycomb (V=7.86 ml)=0.0167 g→w(Pd)=2.93%). The dried honeycombs are dipped in the solution for 20 seconds, blown out to the mass of the water uptake and weighed. They are then dried in the drying oven at 120° C. for two hours and then calcined at 550° C. for three hours (ramp rate 2° C./min).

### Preparation Example 2

### Cu/Mn/La Catalyst

The Cu/Mn/La catalyst to be used within the framework of the present invention is first prepared according to EP 1 197 259 A1, example 1.

This can then be impregnated with Pt. In addition, the obtained tri-holes coated with Cu/La/Mn (grains with a trilobate cross-section with reciprocal through-bores at equal distances in the lobes, wherein the bores were parallel to the axis of the lobes) are comminuted to granules 1-2 mm in diameter. 20 g of the granules are doped with 0.1% Pt. For this, the granules are impregnated with Pt as platinum ethanolamine (w(Pt)=13.87%; Heraeus, batch 77110628) by total adsorption. The required quantity of Pt is filled up to 50 ml with demineralized water. The granules are added and left in the dipping solution over night (for at least 12 hours), in order to ensure that all of the Pt is taken up. The granules are then extracted by suction and dried in the drying oven at 120° C., then calcined at 550° C. for three hours (ramp rate 2° C./min).

### Application Example 1

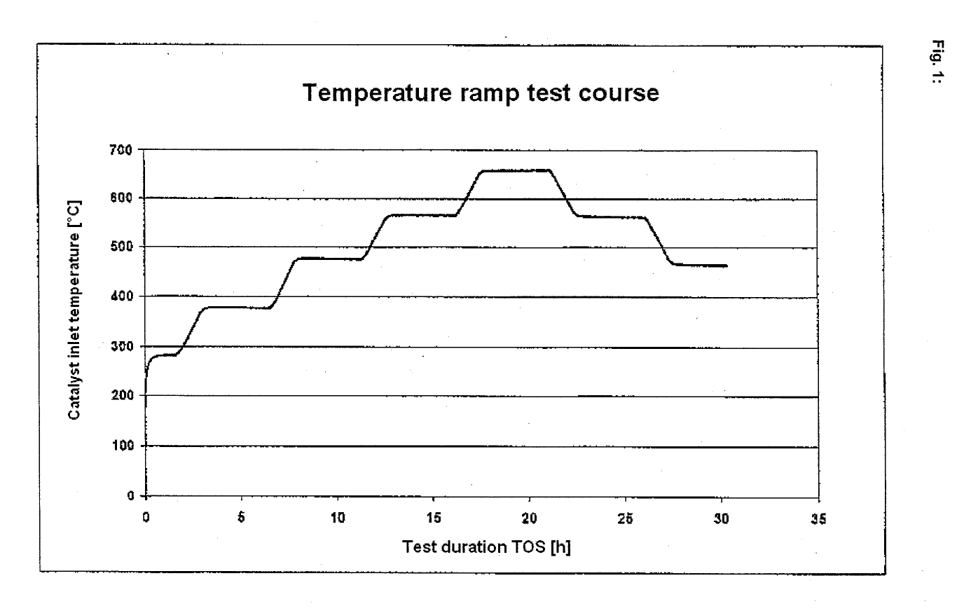

The catalysts are characterized with a steady-state test. The tests are started at 250° C., the temperature increased stepwise to 650° C. and then decreased stepwise to 450° C. The operating conditions are kept constant for a few hours at any temperature level. FIG. 1 shows the corresponding diagram.

### Application Example 2

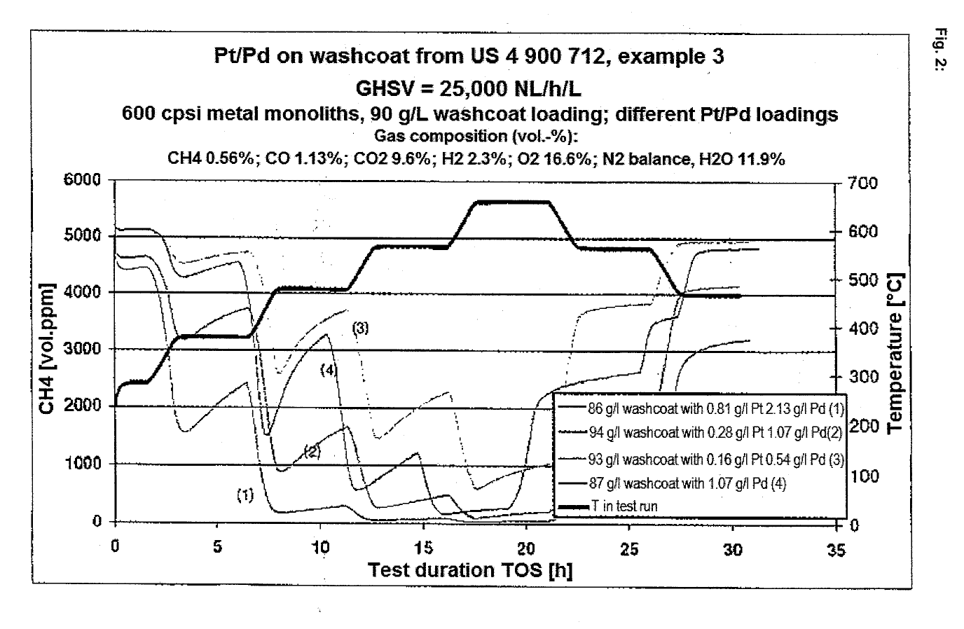

A series of steady-state tests is carried out with coated 600 cpsi metal monoliths (Pd and Pd/Pt and Pt on Al₂O₃, Ce, La, Y). The results are shown in FIG. 2, which shows the catalytic activity of the individual catalysts. A wide distribution of the methane conversion among the catalysts is to be detected. Furthermore, it is clear that a steady state cannot be achieved with these catalysts. The methane conversion decreases sharply as the TOS increases. Although the initial activity of all the noble metal catalysts is high, it is not stable over TOS, even at lower temperatures. Pt/Pd sintering processes could be a possible reason for this.

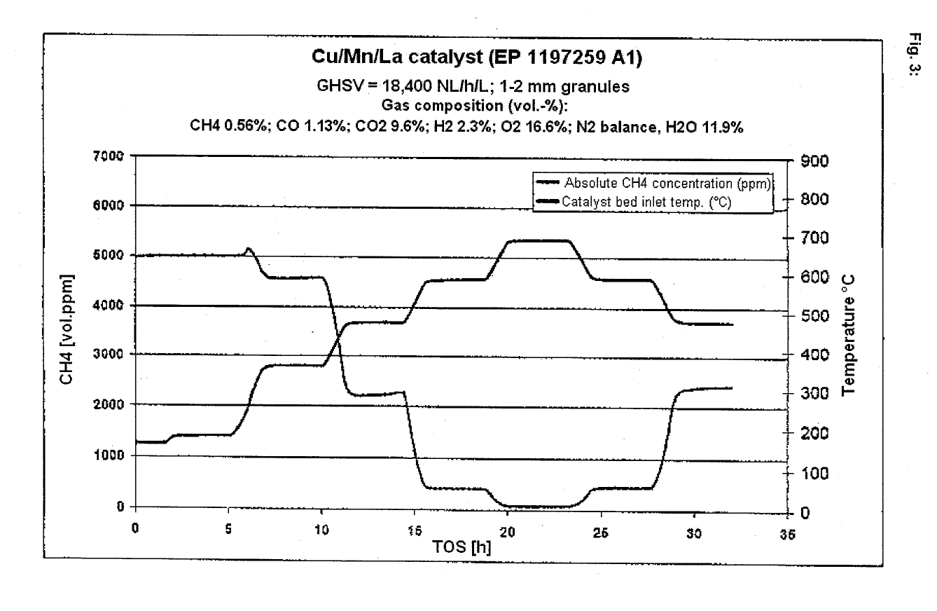

In contrast, and as is clear from FIG. 3, the thermal stability of the catalysts to be used within the framework of the invention was surprisingly high and the activity of the methane conversion at higher temperatures was good. However, it is to be borne in mind that application example 2 (honeycomb catalyst with GHSV=25,000 NL/h/L) must not be directly compared with application example 3 (bulk material catalyst with GHSV=18,400 NL/h/L).

### Application Example 3

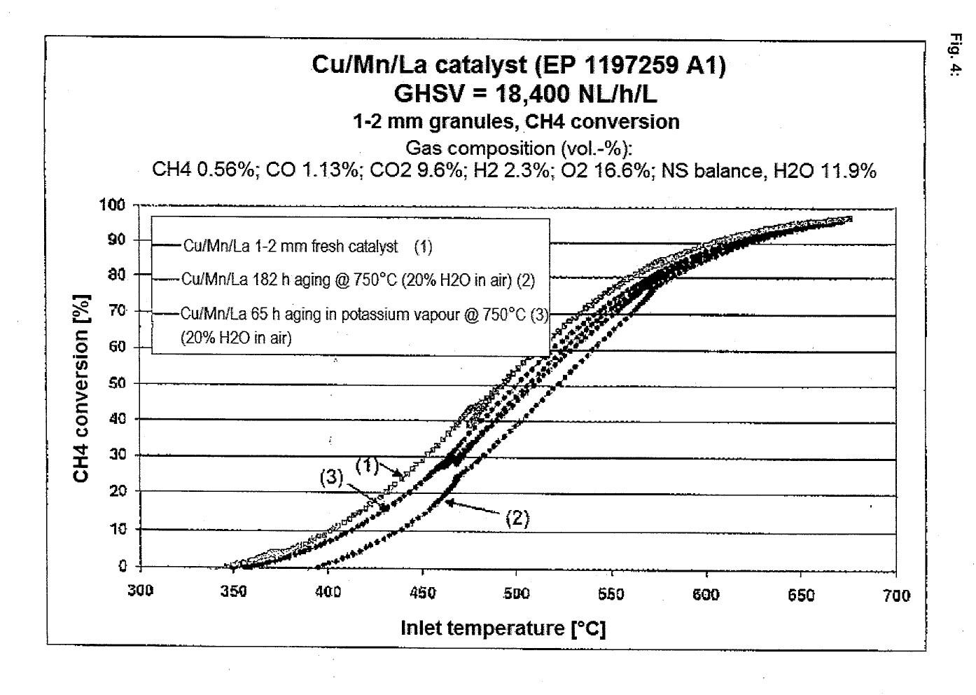

FIG. 4 shows the methane conversion as a function of the inflow temperature in Cu/La/Mn bulk material. The methane conversion of fresh and aged catalyst is good compared with aged noble metal catalysts. The methane conversion is very stable even after hydrothermal aging and hydrothermal potassium aging. The fresh catalysts have a methane conversion rate of 50% at 490° C. and a conversion of >95% at approximately 650° C. inflow temperature. Both aged samples have a low deactivation in the case of methane oxidation activity, but are still very active. In the temperature range above 600° C. inflow temperature, the deactivation is negligible. The additional influence of potassium on the catalytic activity over 65 hours TOS is negligible.

Consequently, because of their excellent cost/benefit ratios and their good hydrothermal stability compared with noble metal catalysts, the catalysts to be used within the framework of the present invention are ideally suited to the oxidative treatment of anode waste gases in fuel cells.

### Application Example 4

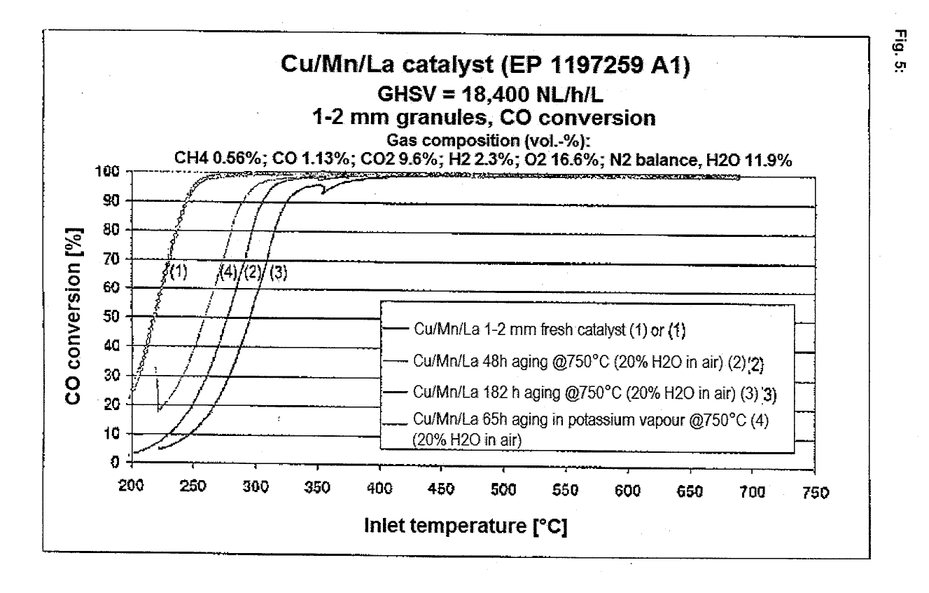

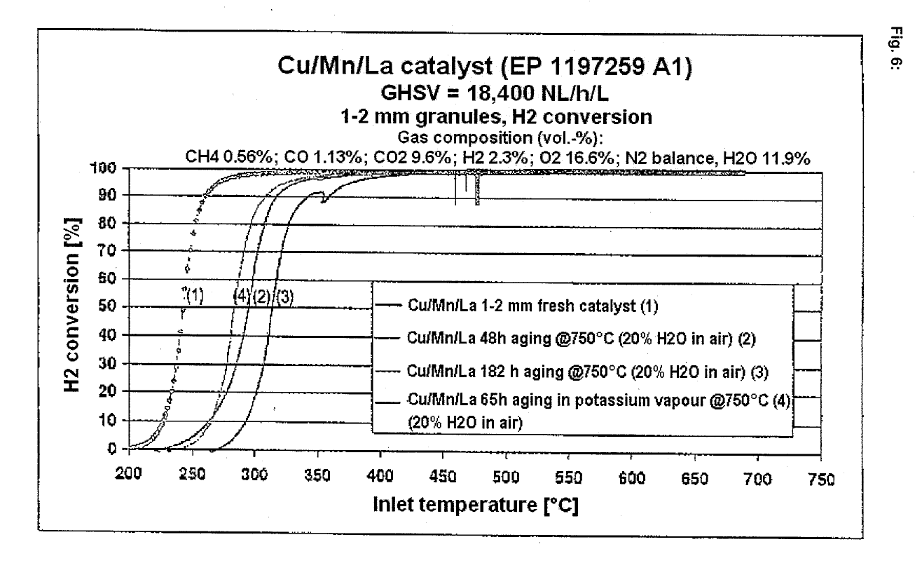

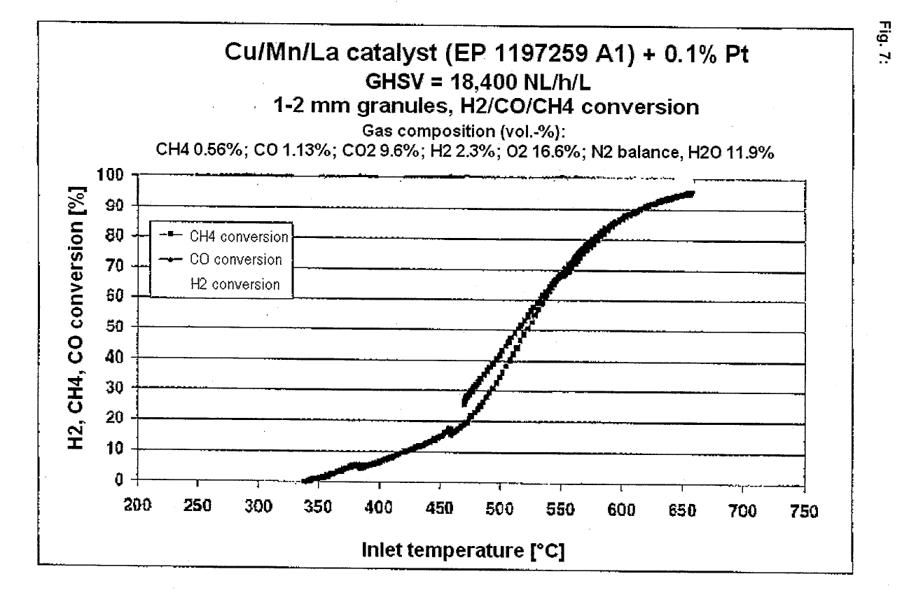

As can be seen from FIGS. 5 and 6, the CO and the H₂ activity decreases after hydrothermal treatment. The scorch temperature for 50% CO and H₂ conversion is initially relatively high, at 220° C. (for CO) and 250° C. (for H₂) respectively. However, the CO and H₂ activity decreases after hydrothermal aging. Interestingly, the potassium-aged catalyst displays a better performance during the CO and H₂ conversion than the normally aged catalysts. As a constant inflow temperature below approximately 250° C. is necessary, a catalyst is doped with 0.1 wt.-% Pt. The total conversion temperature of CO and H₂ was easily reducible to below 250° C. (see FIG. 7).

1. Method for removing CO, H₂ and/or CH₄ from an anode waste gas of a fuel cell comprising passing the anode waste gas over a mixed oxide catalyst comprising Cu and Mn.

2. The method of claim 1 wherein the catalyst further comprises at least one rare earth metal.

3. Method according to claim 1 wherein the passing of the anode waste gas over the catalyst for the removal of CO, H₂ and/or CH₄ from the anode waste gas takes place in a waste gas burner.

4. Method according to claim 1, characterized in that the fuel cell is of the MCFC (molten carbonate fuel cell) or SOFC (solid oxide fuel cell) type.

5. Method according to claim 2, characterized in that the rare earth metals are selected from the group consisting of lanthanum and cerium.

6. Method according to claim 2, characterized in that the mixed oxide catalyst comprises an oxidation catalyst, comprising mixed oxides of copper, manganese and one or more rare earth metal(s), wherein the metals can assume multivalence states which have a weight-percent composition expressed as and relative to the total mass of Cu, Mn and rare earth metal, in which the rare earth metal has the lowest valence, of 20 to 60%, 80 to 20% and 5 to 15% respectively.

7. Method according to claim 2, characterized in that the catalyst has the following composition (as weight percent relative to the named oxides): 35 to 40% CuO, 50 to 60% MnO and 10 to 15% La₂O₃ and the individual metals can assume different oxidation states.

8. Method according to claim 1, characterized in that the mixed oxides are supported on inert, porous, inorganic supports.

9. Fuel cell arrangement, comprising a fuel cell containing a waste gas burner, characterized in that the waste gas burner includes mixed oxide catalyst comprising Cu and Mn.

10. Fuel cell arrangement according to claim 9, characterized in that the fuel cell is of the MCFC (molten carbonate fuel cell) or SOFC (solid oxide fuel cell) type.

11. Fuel cell arrangement according to claim 9, characterized in that the mixed oxide catalyst comprises an oxidation catalyst, comprising mixed oxides of copper, manganese and one or more rare earth metal(s), wherein the metals can assume multivalence states which have a weight-percent composition expressed as and relative to Cu, Mn and rare earth metal, in which the rare earth metal has the lowest valence, of 20 to 60%, 80 to 20% and 5 to 15% respectively.

12. Fuel cell arrangement of claim 9 wherein the mixed oxide catalyst further comprise at least one rare earth metal.
